(19) United States
(12) Patent Application Publication
(10) Pub. No.: US 2011/0100338 A1
(43) Pub. Date: May 5, 2011

(54) Fuel injector

(76) Inventor: Jan Vetrovec, Larkspur, CO (US)

(21) Appl. No.: 12/803,131

(22) Filed: Jun. 18, 2010

Related U.S. Application Data
(60) Provisional application No. 61/268,945, filed on Jun. 18, 2009.

(51) Int. Cl. F02M 53/04

(52) U.S. Cl. 123/557

(57) ABSTRACT

The invention is for an apparatus and method for a fuel injector enabling improved combustion in automotive engines. In one embodiment of the invention, fuel is preheated for greatly improved atomization and evaporation, especially during cold engine start. As a result, harmful pollution is greatly reduced pollution. In addition, alcohol-based automotive fuel may be used in cold ambient conditions. The invention overcomes the limitations of current electrically heated injectors and fuel rails having large thermal inertia and long preheat times. In another embodiment of the invention, optically-driven acoustic waves assist in atomization of injected fuel, thus resulting in reduced engine emissions and improved efficiency. Other applications include production of finely atomized fluid sprays for the manufacture of substrates for industry, applications of coatings, formation of uniform-sized particles for the production of pharmaceutical products, and thin-film deposition techniques for forming resistors, capacitors and other components.

### CROSS-REFERENCE TO RELATED APPLICATIONS

This application claims priority from U.S. provisional patent application U.S. Ser. No. 61/268,945, filed on Jun. 18, 2009 and entitled “Heated Fuel Injector.”

### FIELD OF THE INVENTION

This invention relates generally to heating of fluids by heat generated by optical radiation and more specifically to heating of fuels for internal combustion engines.

### BACKGROUND OF THE INVENTION

The subject invention is an apparatus and method for heating of fluids by heat generated by absorption of optical radiation and more specifically to heating of fuels prior to injection into internal combustion engines.

Today's standards for low and ultra-low emissions vehicles require increased research and development in unburned hydrocarbon emissions, particularly in operations such as engine cold starts. Some studies show that about 90% of nitrous oxides (NOX) and hydrocarbon (HC) emissions from automotive engines is produced during cold starts. In the cold start operating mode, the initial compression strokes ordinarily take place with cold intake valves, and cold port and cylinder walls. Consequently, the fuel evaporation rate is slow even though the overall air/fuel mixture is within ignitable limits. These effects become more severe if the ambient temperature drops below 0° C. In addition, then using alternative fuels with high flash point such as alcohol, fuel ignition in freezing conditions becomes extremely challenging, see, for example W. J. Imoel, “Method of using an internally heated tip injector to reduce hydrocabon emissions during cold-start,” U.S. Pat. No. 6,332,457, Dec. 25, 2001, which is hereby incorporated by reference in its entirety.

In general, the completeness and cleanliness of liquid fuel combustion depends upon the fuel/air ratio, the combustion chamber mechanical and aerodynamic design, the fuel type, the fuel injector design and the fuel droplet size distribution. A primary driver in combustion system design in recent years has been the reduction of combustion-generated emissions. This has applied across a broad range of applications, from residential heating equipment to automotive internal combustion engines to gas turbines to industrial and utility furnaces. The liquid fuel preparation method has a very significant impact on the resultant emissions, particularly emissions of carbon monoxide (CO), unburned hydrocarbons and soot. Thus in the drive to continuously reduce emissions from liquid fuel burning devices, there has been much effort directed at developing simple and cost-effective methods for achieving delivery of either vaporized fuel or very fine fuel droplets.

In any given liquid fuel combustion application, reduction of the droplet size can provide several benefits, including improved ignition characteristics, reduced droplet impingement on chamber walls, more rapid evaporation of the liquid droplets, reduced CO, hydrocarbons and soot emissions, and the ability to operate with lower volatility (or heavier) liquid fuels. Though a fuel may be delivered to a combustion chamber in liquid droplet form, the liquid must evaporate before the fuel constituents can react with the oxygen in the combustion air. Large droplets evaporate slowly and may not have time to fully evaporate and react before exiting the combustion chamber, thereby resulting in higher emissions.

In particular, in the case of very small-scale combustion systems (less than, say, 10 kW heat release), the importance of achieving small droplet sizes is made all the more critical, especially for lower volatility fuels such as diesel or jet fuel. In addition, these small-scale systems require simple fuel delivery systems that do not use large amounts of power to prepare the fuel. Thus many of the conventional fuel delivery approaches (e.g. pressure atomization, twin-fluid or duplex atomization, ultrasonic atomization) cannot be applied to small-scale systems because their fuel flow rates are too high, fuel droplets are too large, required fuel supply pressures are too high, or an additional atomizing fluid is required. Thus many small-scale combustion systems are limited to gaseous fuels.

Engine fuel can be heated prior to injection to improve vaporization. Even though the advantages of fuel vaporization by heating are well known, the automotive industry has not adopted several concepts because they have been considered impractical. In particular, heating the fuel delivery manifold having a large thermal inertia leads to excessive warm-up times while risking the possibility of a vapor lock. A preferred approach is to heat the fuel inside the injector just prior to delivery into engine intake manifold or combustion chamber.

Heating the fuel inside the fuel injector has several advantages including small heated fuel volume (enhanced safety) and selfcontained packaging, The heater may be an electrically heated element in direct contact with the fuel, thus promoting faster heating. In addition, the heater can be turned off very quickly when not needed, allowing the heated tip injector to function as a normal fuel injector with well-defined targeting. The key challenges include:

1) Constructing a reliable and inexpensive electric heater generating about 100 W of heat in a volume of about 1 cm³ or smaller
2) Fast turn-on time (<1 sec)
3) Thermally insulating the heater thermally from the body of the injector
4) Limiting the pressure drop in fuel flow to less than about 50 kPa
5) Assuring that arcing at the (physically very small) electrical connections to the heating element can be prevented. This is critical for operating safety because arcing may potentially lead to a fire in the engine compartment or even an explosion.

Recently, several electrically-heated injector concepts have been introduced. The turn-on times of these devices is around 5 seconds, which may be an unacceptably long delay in many applications. While this delay may used to preheat the injector prior to cranking during engine start, it may be too excessive for most users. When the heater is turned on at the same time as the cranking action, excessive amount of pollutants may be emitted. The delay may be primarily caused by the thermal inertia of the heater element.

Recently, an electrically heated injector concept was proposed in R. O Pellizzari, “Apparatus and method for preparing and delivering fuel,” U.S. Pat. No. 7,225,998, Jun. 5, 2007, which is hereby incorporated by reference in its entirety. Pellizzari's injector is using an electrically capillary. To achieve the required rise in fuel temperature, this approach leads to a relatively long capillary undesirably protruding beyond the end of the injector body. While this may be acceptable for port injected engines, the protrusion is undesirable for internal combustion engines where fuel is injected directly into engine combustion chambers (also known as directly injected engines). A much better packaged electrically heated injector has been recently developed by Delphi specifically for use with alcohol fuel in cold environment. See, for example, D. Kabasin, K. Hoyer, J. Kazour, R. Lamers, and T. Hurter, “Heated injectors for ethanol cold starts,” SAE paper no. 2009-01-0615, April 2009. However, this device appears to exhibit about 5 second delay in bringing alcohol fuel to a target temperature.

The ability to produce finely atomized fluid sprays benefits many diverse applications including the manufacture of substrates for industry, applications of coatings, the fueling of combustion systems, including the fueling of internal and external combustion engines, the formation of uniform-sized particles for the production of pharmaceutical products, the production of small particles for use as test standards and various applications in the electronics industry, in which thin-film deposition techniques are often employed to form resistors, capacitors and other components.

### SUMMARY OF THE INVENTION

The present invention provides a heated fuel injector enabling improved combustion in automotive engines. The subject heated fuel injector uses a light absorbing element activated by a narrow band light radiation generated by a suitable light source. The light absorber/heater may be physically small having low thermal inertia and a large surface area, and it may be immersed in the flow of liquid fuel for superior heat transfer and minimum heat leakage to injector body. Fuel is heated by physical contact with the absorber. In another embodiment of the heated fuel injector, light radiation having a wavelength band matched to the absorption spectrum of the liquid fuel is directed into the liquid fuel and absorbed therein, thereby heating the fuel.

In a yet another embodiment, light radiation delivered in a pulsed format is focused inside the liquid fuel to cause an electrical breakdown in the liquid to generate acoustic waves and/or to heat the liquid fuel. The acoustic waves may be in the ultrasound regime and assisting in further atomization of the fuel injected by the injector.

In a still another embodiment, the strength of the optical radiation may be made sufficient to evaporate a portion of the fuel, thus causing a significant pressure rise inside the injector body. Thus generated pressure may be used to open the injector valve and inject a portion of the fuel inside the injector into a combustion apparatus.

Accordingly, it is an object of the present invention to provide an improved heated fuel injector. The fuel injector of the present invention is simple, compact, lightweight, self-contained, requires relatively little power to operate, and it is suitable for large volume production.

It is another object of the invention to provide means for heating hydrocarbon fuel prior to injection into internal combustion engine.

It is still another object of the invention to provide means for evaporating at least a portion of hydrocarbon fuel prior to injection into internal combustion engine.

It is yet another object of the invention to improve atomization of hydrocarbon fuel.

It is yet further object of the invention to improve evaporation of hydrocarbon fuel.

It is a further object of the invention to flash evaporate at least a portion of hydrocarbon fuel prior to injection into internal combustion engine.

It is still further object of the invention to reduce emissions from internal combustion engines.

It is an additional object of the invention to accelerate the startup of an internal combustion engine.

These and other objects of the present invention will become apparent upon a reading of the following specification and claims.

### BRIEF DESCRIPTION OF THE DRAWINGS

FIG. 1 is a side cross-sectional view of the fuel injector assembly accordance with one embodiment of the subject invention.

FIG. 2 is an enlarged view of portion 2 in FIG. 1 showing the details of the light absorber/heater.

FIG. 3 is a cross-sectional view 3 of the absorber of FIG. 2 in a plane transverse to fuel flow.

FIG. 4 is a side cross-sectional view of an alternative light absorber/heater configuration.

FIG. 5 is a side cross-sectional view of the fuel injector assembly accordance with another embodiment of the subject invention.

FIG. 6 is a side cross-sectional view of the fuel injector assembly accordance with yet another embodiment of the subject invention.

### DETAILED DESCRIPTION OF THE PREFERRED EMBODIMENTS

Selected embodiments of the present invention will now be explained with reference to drawings. In the drawings, identical components are provided with identical reference symbols in one or more of the figures. It will be apparent to those skilled in the art from this disclosure that the following descriptions of the embodiments of the present invention are merely exemplary in nature and are in no way intended to limit the invention, its application, or uses.

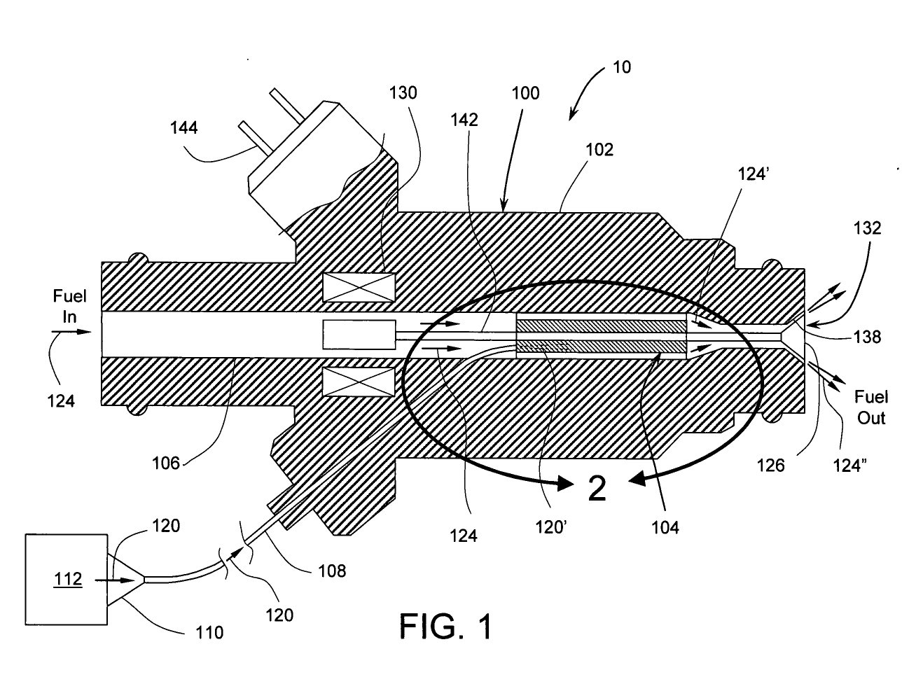

Referring now to FIG. 1, there is shown a fuel injector system 10 in accordance with one embodiment of the subject invention. The fuel injector system 10 may a fuel injector assembly 100, light source 112, and optical fiber 108. The fuel injector assembly 100 may further comprise an injector body 102, valve 132, actuator 130, valve 132, light absorber/heater 104. The injector body 102 may further include a fuel flow channel 106 and an electrical control connector 144. The fuel flow channel 106 is arranged to receive liquid fuel from a fuel supply. The actuator 130 is arranged to operate the valve 132. For example, the actuator 130 may be mechanically connected to the valve 132 via the valve stem 142 and cause the valve to open and close in accordance with applied control signals. The actuator may be an electro-mechanical actuator, piezo-electric actuator, hydraulic actuator, or any other suitable actuator. The valve 132 may be a poppet style valve having a poppet 126 and a seat 138, or any other suitable style valve. A spring (not shown) may be used to return the valve to its closed position. The valve 132 may be arranged to inject fuel into a combustion chamber of an internal combustion engine either directly, or via an intake manifold or intake port. Alternatively, the valve 132 may be arranged to inject fuel into a combustion chamber of an external combustion device, such as a furnace or a heater.

The light absorber/heater 104 may be located downstream of the actuator 130 or upstream thereof. The light source 112 is optically connected to the light absorber/heater 104 via an optical waveguide 108. The light source 112 preferably comprises one or more semiconductor laser diodes mounted on a suitable heat sink and connected to a source of electric power. Most preferably, the light source 112 is an array of narrow-band high-power laser diodes configured on a common substrate (also known as a “bar”) and mounted on a passive or active heat sink. The optical output 120 of the light source 112 may be coupled to the waveguide 108 via a suitable coupler 110. Suitable coupler may use micro-optical elements such as available from Lissotchenko Microoptik (LIMO), in Dortmund, Germany. The waveguide 108 may be made of glass or other suitable optical material. For short operating times, the waveguide 108 may be made of a suitable transparent plastic. The waveguide 108 may be also configured as an optical fiber.

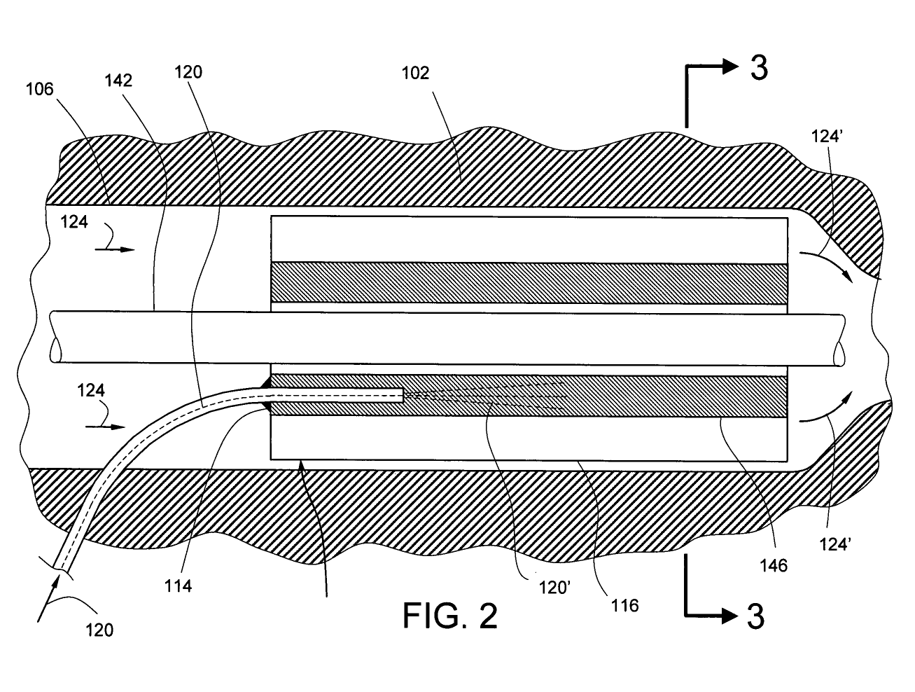

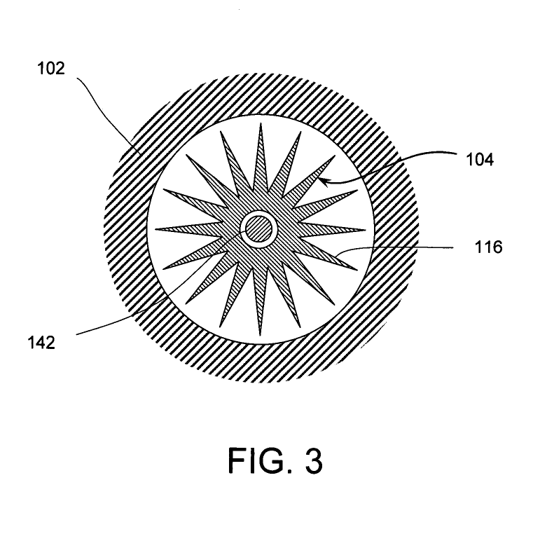

Referring now to in FIG. 2, the light absorber/heater 104 may be configured inside the flow channel 106 and it may envelop the valve stem 142. The light absorber/heater 104 may have a core portion 146 and surface extensions 116 attached thereto. Preferably, the core portion 146 and the surface extensions are made from one piece of material. Suitable surface extensions may be fins. FIG. 3 shows the transverse cross-section of an exemplary light absorber/heater 104 generally configured in a star-like shape. Other configurations of the light absorber/heater 104 suitable for good thermal communication between the light absorber/heater 104 and the liquid fuel may be also used. For example, the light absorber/heater 104 may be formed as a cylinder with a plurality of small flow channels parallel to the flow of fuel in the flow channel 106. As another example, the light absorber/heater 104 may be made of porous material.

The light absorber/heater 104 is made of a material adapted to gradually absorb light at the wavelength of the optical radiation 120. For example, the light absorber/heater 104 may be made of yttrium aluminum garnet (YAG), glass, or sapphire doped with suitable ions having a sufficiently broad and strong absorption spectrum at the wavelength of optical radiation 120. YAG material, may be provided in a single crystal or polycrystalline form. Suitable absorbing ions may include rare earths such as ytterbium (Yb) and samarium (Sm), and metals such as chromium (Cr) and copper (Cu). For example, light radiation 120 may have a wavelength 940 nanometers and the absorbing ion may be Yb having a broad absorption band in vicinity of 940 nanometers when doped in to YAG.

Alternative materials for the light absorber/heater 104 may be materials having generally good optical transmission at the wavelength of the optical radiation 120 and including light absorbing or light scattering inclusions. Such suitable materials may include the previously stated YAG, glass, and sapphire, as well as silicon carbide and yttrium oxide. The light absorber/heater 104 may be physically small (preferably 1 to few millimeters in diameter and 10 to 50 millimeters long). As a result, the light absorber/heater 104 may have desirably low thermal inertia. Furthermore, the surface extensions 116 provide the light absorber/heater 104 with desirably high surface area for efficient transfer of heat into the liquid fuel inside the flow channel 106.

The downstream portion of the waveguide 108 is optically connected to the light absorber/heater 104. For example, the light absorber/heater 104 may have a hole and the end of the optical waveguide 108 may be fitted into the hole as shown in FIG. 2. An index matching material may be provided between the waveguide end and the light absorber/heater 104 to ensure that nearly all of the light radiation 120 produced by the light radiation source 112 is delivered into the light absorber/heater 104. The exterior surfaces of the light absorber/heater 104 may be coated with coating reflecting at the wavelength of the optical radiation 120 to avoid significant leakage of light from the light absorber/heater.

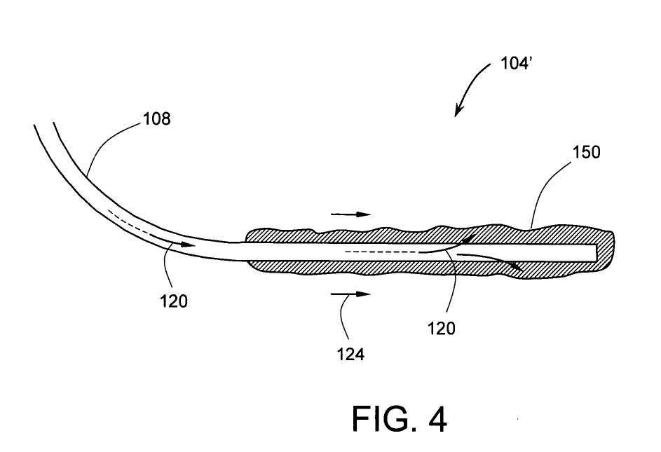

FIG. 4 shows an alternative configuration of the light absorber/heater 104′ may be formed as a cladding 150 on the end of the waveguide 108. For example, if the waveguide 108 is formed as an optical fiber made of glass, suitable cladding 150 may be produced by momentarily dipping the end of the fiber into a molten glass doped with suitable absorbing ions. Preferably, the cladding glass has a lower melting point than the optical fiber.

In operation, liquid fuel is delivered as a stream 124 from a suitable fuel supply into the flow channel 106 of the injector assembly 100. Light radiation source 112 is activated to generate optical radiation 120 preferably in a continuous mode and to direct it via coupler 110 into the optical waveguide 108. The optical waveguide 108 transmits the optical radiation and delivers it as optical radiation 124′ into the light absorber/heater 104 where it is gradually absorbed. In the absorption process, the light energy is efficiently converted into thermal energy, which heats the light absorber/heater 104 and significantly raises its temperature above the temperature of the liquid fuel stream 124. Because the light absorber/heater 104 is in a good thermal communication with the liquid fuel, the fuel is being heated as it comes into contact with the light absorber/heater 104, thereby forming a warm fuel stream 124′. When the valve 126 opens, the warm fuel is injected as a spray stream 124″ into a combustion chamber of an internal combustion engine either directly or via an intake manifold or intake port. Warm fuel prepared by the fuel injector of the subject invention may be moiré finely atomized and may be more easily ignited, thereby allowing for a quick start and reduced cranking time during cold engine start. As a result, harmful emissions during engine cold start are greatly reduced. The optical radiation source 112 may be turned off once the engine has started, or it may be operated for a predetermined amount of time, or it may be operated until certain conditions are met, or it may be operated indefinitely.

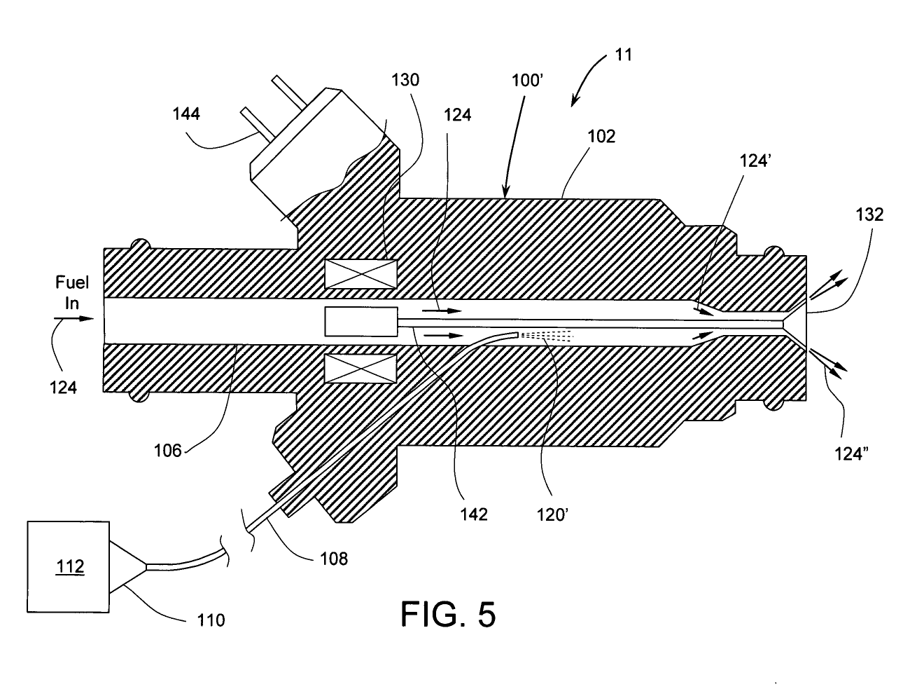

Referring now to FIG. 5, there is shown a fuel injector system 11 in accordance with another embodiment of the subject invention. The fuel injector system 11 is similar to the fuel injector system 10 of FIG. 1, except that the light absorber/heater 104 has been omitted. In particular, the waveguide 108 is arranged to deliver optical radiation 120′ directly into the liquid fuel. The waveguide 108 end may be equipped with appropriate antireflection coatings to ensure efficient delivery of optical radiation to the fuel. The optical radiation source 112 is arranged to operate at a wavelength conducive to good optical absorption in the fuel. For example, certain hydrocarbon fuels have optical absorption bands in the 2-4 micrometer range due to C-H and O-H vibrational states that may be utilized for this purpose. High-power laser diodes in this range are now becoming commercially available. The end of the waveguide 108 may include a lensing element (possibly integrated with the waveguide) allowing for spreading of the light radiation in the fuel. The optical radiation 120 is thus absorbed directly in the fuel and heats the fuel directly.

A variant of the fuel injector system 11 uses a pulsed optical radiation source 112 producing relatively short (preferably 1-1000 nanoseconds long and most preferably less than 1 nanosecond long) pulses of high energy content (preferably 1-100 mJ per pulse). Preferably, the end of the waveguide 108 includes a lensing element (possibly integrated with the waveguide) allowing for focusing of the light radiation in the fuel relatively short distance (preferably 1-20 millimeters) away from the waveguide end. The optical radiation 120′ delivered by the waveguide 108 may be focused in the liquid fuel to ultra-high energy densities in the range of MJ/m². It is well known that the ultra-high electric fields generated by focusing high-energy-content laser pulses in liquids may cause electrical breakdown in the liquid fuel and facilitate a very efficient absorption of the optical energy via non-linear processes. The non-linear absorption process does not require that the optical radiation 120′ be tuned to optical absorption bands of the fuel. Deposition of laser energy into the liquid fuel near the focus generates a microburst, which may result in evaporation of some of the fuel. The microburst thus causes a very intense pressure wave. With optical radiation pulses repeated at appropriately high frequency, ultrasonic pressure waves may be generated in the fuel inside the flow channel 106. Such pressure waves may be reflected and directed toward the valve 126 by using appropriately shaped walls of the flow channel 106. The optical radiation pulse rate tuned to the resonance of the acoustic cavity formed by the flow channel, the pressure of ultrasonic waves may be amplified. Acoustic energy added to the fuel flow enhances atomization once the fuel is injected into a combustion chamber.

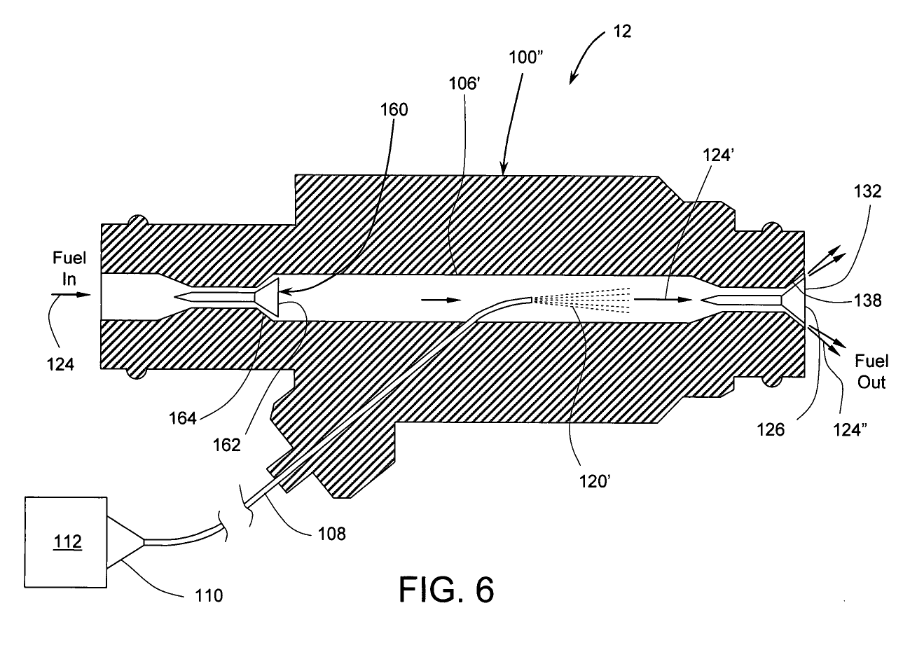

Referring now to FIG. 6, there is shown a fuel injector system 12 in accordance with yet another embodiment of the subject invention. The fuel injector system 12 is similar to the fuel injector system 11 of FIG. 5, except that the actuator 130 has been omitted. As a result, the valve 126 now may be formed as a check valve, which opens automatically by pressure increase in the fuel inside the fuel flow channel 106. Moreover, the valve 126 now closes automatically (e.g., by a spring) when the pressure in the fuel inside the fuel flow channel 106′ is reduced. Furthermore, a valve 160 has been added in the flow channel 106 upstream of the location where the optical radiation 120′ is delivered into the fuel. The valve 160 may be a poppet style valve having a poppet 162 and a seat 164, or any other suitable style valve. A spring (not shown) may be used to return the valve to its closed position. The valve 162 is formed as a check valve and it is arranged to open automatically when the pressure in the fuel inside the fuel flow channel 106′ is less than the fuel pressure in the fuel supply line feeding the injector. In addition, the valve 162 is arranged to close automatically when the pressure in the fuel inside the fuel flow channel 106′ is higher than the fuel pressure in the fuel supply line feeding the injector.

In operation, when fuel injection is required, a pulse of light radiation 120 may be delivered into the fuel inside the fuel flow channel 106′, heating a portion of the fuel nearly instantaneously, and evaporating at least a small portion of the fuel. Evaporation of the fuel increases the pressure in the fuel flow channel 106′. Increase the fuel channel pressure causes the valve 160 to close and the valve 126 to open. As a result, the fuel stream 124′, which may be a mixture of liquid and vapor, is ejected from the injector and forms a spray stream 124″. The fuel may be sprayed at a sufficiently high velocity suitable for injection into either an engine intake port or directly injected into engine cylinders without any additional pumping. Once at least a portion of the fuel exits the channel 106′, the valve 126 closes. Collapse of the fuel vapor bubbles inside the flow channel 106′ causes momentary low pressure therein. As a result, the valve 160 opens, allowing more fuel 124 to flow into the fuel flow channel 106′ and the process may be repeated. In this embodiment of the invention, the light radiation 120 not only heats and atomizes the fuel but also meters it. In a variant of this embodiment, one or both of the valves 126 and 160 may be operated electromechanically, piezoelectrically, hydraulically, or by other suitable means.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” and “includes” and/or “including” when used in this specification, specify the presence of stated features, integers, steps, operations, elements, and/or components, but do not preclude the presence or addition of one or more other features, integers, steps, operations, elements, components, and/or groups thereof.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

The term “suitable,” as used herein, means having characteristics that are sufficient to produce a desired result. Suitability for the intended purpose can be determined by one of ordinary skill in the art using only routine experimentation.

Moreover, terms that are expressed as “means-plus function” in the claims should include any structure that can be utilized to carry out the function of that part of the present invention. In addition, the term “configured” as used herein to describe a component, section or part of a device includes hardware and/or software that is constructed and/or programmed to carry out the desired function. Different aspects of the invention may be combined in any suitable way.

While only selected embodiments have been chosen to illustrate the present invention, it will be apparent to those skilled in the art from this disclosure that various changes and modifications can be made herein without departing from the scope of the present invention as defined in the appended claims. Furthermore, the foregoing description of the embodiments according to the present invention are provided for illustration only, and not for the purpose of limiting the present invention as defined by the appended claims and their equivalents. Thus, the scope of the present invention is not limited to the disclosed embodiments.

What is claimed is:

1. A fuel injector system comprising:
a) a fuel injector for delivery of liquid fuel for fueling of a combustion device, said fuel injector having a fuel flow channel containing a liquid hydrocarbon fuel;
b) a source of light radiation generating light radiation;
c) a means for delivering said light radiation into said fuel flow channel;
d) a means for absorbing said light radiation in said fuel flow channel and converting said light radiation into heat; and
e) a means for depositing said heat into a liquid fuel in said fuel flow channel.

2. The fuel injector system of claim 1, wherein said liquid hydrocarbon fuel is substantially gasoline.

3. The fuel injector system of claim 1, wherein said liquid hydrocarbon fuel is substantially alcohol.

4. The fuel injector system of claim 1, wherein said light radiation has an optical spectrum substantially overlapping with the optical absorption spectrum of said hydrocarbon fuel.

5. The fuel injector system of claim 1, wherein said source of light radiation comprises laser diodes.

6. The fuel injector system of claim 1, wherein said means for delivering said light radiation into said fuel flow channel comprise an element selected from the group consisting of optical waveguide, optical fiber, and an optical window.

7. The fuel injector system of claim 1, further comprising a light absorber/heater.

8. The fuel injector system of claim 1, wherein said light radiation is generated as a stream of pulses having a temporal duration in the range of 1 to 1000 nanoseconds and having an optical energy in the range of 0.001 to 0.1 Joules.

9. A liquid injector system comprising:
a) an injector for delivery of liquid substance, said injector having a flow channel containing a liquid substance;
b) a source of light radiation generating light radiation;
c) a means for delivering said light radiation into said flow channel;
d) a means for absorbing said light radiation in said flow channel and converting said light radiation into heat; and
e) a means for depositing said heat into a liquid substance in said flow channel.

10. A method fueling internal combustion engine comprising the steps of:
a) flowing a liquid hydrocarbon fuel through a fuel flow channel;
b) generating light radiation;
f) delivering said light radiation into said fuel flow channel;
g) absorbing at least a portion of said light radiation in said fuel flow channel;
h) heating said liquid fuel in said fuel flow channel thereby producing heated fuel; and
i) delivering said heated fuel into a combustion chamber of an internal combustion engine.
